(19) United States
(12) Patent Application Publication
(10) Pub. No.: US 2005/0277463 A1
(43) Pub. Date: Dec. 15, 2005

(54) Method and system for monitoring and directing poker play in a casino

(76) Inventors: Randy L. Knust, The Woodlands, TX (US); Eric Schoppe, Conroe, TX (US)

Correspondence Address: TIM COOK, P.O. BOX 10107, LIBERTY, TX, 77575, US

(21) Appl. No.: 11/160,183

(22) Filed: Jun. 13, 2005

Related U.S. Application Data
(60) Provisional application No. 60/579,726, filed on Jun. 15, 2004.

(51) Int. Cl. A63F 13/00

(52) U.S. Cl. 463/29

(57) ABSTRACT

A system and method for quickly and easily clocking in a player to a poker table in a casino are provided. A control panel is installed on the poker table at a location that is easily accessible by a dealer. When a player sits down at an empty spot at the table, the dealer accepts the players ID card, swipes the player's identification into the system, and then presses a dedicated button on the control panel associated with that seat. The information is received by the system and transmitted to a central computer. If the player wants to take a break from play, such as for example to go to eat, then the dealer presses a button on the control panel to indicate that the player is still assigned to that seat, but is temporarily away from the poker table. The system further includes means for maintaining a waiting list of players awaiting play in the poker room and for tracking the play of a plurality of poker players in a tournament setting.

This application claims the benefit of U.S. Provisional Application Ser. No. 60/579,726 filed Jun. 15, 2004.

### FIELD OF THE INVENTION

The present invention relates generally to the field of gaming and, more particularly, to a system and a method for monitoring and directing supervisors, dealers chip runners, food and beverage personnel, and players in a poker room in a casino, including but not limited to tracking the accumulated time of play for a gambler for purposes of awarding a prize or a bonus. The invention further provides overall management of a poker room in a casino including tournament play and waiting list management.

### BACKGROUND OF THE INVENTION

The play of poker in casinos and similar gaming places has recently enjoyed a renaissance of popularity. In fact, poker may be more popular today than ever before. This is due in part to the increase in the number of televised poker tournaments with celebrities and/or professional gamblers and also due to the number of amateurs playing competitive poker with other amateurs in casinos and even on-line over the World Wide Web.

Casino operators often like to reward their customers who are loyal to them with perquisites or awards which help to keep these loyal customers coming back. One way that casino operators award their frequent customers is through a “comp” which is frequently based on how much time the customer has spent playing poker at the casino.

One common method in use today to carry out this plan involves a casino employee making the rounds of a poker room periodically to record the presence of players at the various poker tables. Each poker player has an identification card with a magnetic stripe to identify the player, and the casino employee goes around the room scanning the information from the magnetic stripes into a portable device. One can easily see that the player need not be present between the times that he is counted present by the casino employee to gain credit for the entire period.

Other casinos do not even use an electronic device, but instead record the presence of players onto a paper record that is taken down by the employee during the rounds. This paper record is manually maintained over time and, when an individual player has recorded a predetermined period of time at the poker tables, he or she is awarded some kind of compensation.

In certain other casinos, when a player enters a poker room to play poker at one of the tables, he goes to a podium or other central location in the poker room with his card with the magnetic stripe to clock into the system. Then, when he is through playing, he goes back to the podium or other central location to clock out. The accumulated time between clocking in and clocking out is thus recorded.

One can immediately see that the systems just described are labor intensive and cumbersome, and therefore expensive. Furthermore, a player can be clocked in with such a system, leave the poker table, then return before the next “roll call” and get credit for the entire interval between recordings. These and other inaccuracies in maintaining such systems cost the casinos money and therefore impact the profit margin for their poker rooms.

Poker rooms at casinos are also commonly used today for tournaments for players at all levels of experience. During a tournament, the casino operator is not so concerned about tracking the duration of play of individual players as he is in monitoring and managing the tournament as a whole. One goal of the tournament director is a random distribution of players at the various tournament tables. Then, as players are eliminated from the tournament, the players are randomly reassigned to the remaining tables and play resumes.

Poker room managers must also keep track of patrons wishing to play certain poker games when there are no immediate seats available for those games. The poker management keeps “waiting lists” to queue and call patrons for available seating at poker tables. These “waiting lists” are often kept manually via a clipboard or a whiteboard at a podium or central location within the poker room. Patron names are typically announced over a public address system when their seat at a desired table becomes available.

During live play, often times dealers need to call for a chip fill or credit at the table. New players will buy-in or existing players will buy additional chips. Typically, chip runners or floor supervisors are verbally called to the table for additional chips to be delivered. This causes annoying distractions to the players at the table and in the poker room.

Often times during poker play, a supervisor must be called to the table to make a decision where play has been interrupted by a dealer mistake, patron complaint or question. Typically, the dealer verbally calls the supervisor to the table for the decision. This causes annoying distractions to the players at the table and in the poker room.

When a player leaves a poker table, the dealer must call the supervisor to indicate an open seat at the table. It is important to fill the vacant seat as quickly as possible not only for poker room financial reasons but for existing players' satisfaction. This typically causes annoying distractions to the players at the table and in the poker room.

In each of these scenarios, the casino operator is of course interested in making money from the play of poker in his casino. Thus, there remains a need for a system for keeping track of players at poker tables during routine (i.e. non-tournament play) that does not require any additional personnel but eliminates the likelihood of players being given credit for time that they are not actually playing at a poker table. The system should also be adapted to keep track of the play of poker in a tournament environment as well as offer a tool for waiting list management. Such a system should also provide automated handling of the other distracting events described above, and be adaptable to needs of individual gaming establishments. The present invention is directed to filling this need in the art.

### SUMMARY OF THE INVENTION

The present invention is directed to a system and method of monitoring the play of poker players throughout a poker room in a casino. The system is also directed to monitoring play of poker during a poker tournament, including a plurality of different types of games of poker or modes of play. In addition, the system is also directed to monitoring a queue of players waiting to play poker games when seats become available.

The present invention further provides a system and method for quickly and easily clocking a player into the system for play at a poker table in a casino. A control panel is installed on each poker table at a location that is easily accessible to a dealer. When a player sits down in an empty chair at the table, the dealer accepts the player's ID card, swipes the player's identification into the system, and then presses a dedicated button on the control panel associated with that seat. Other types of player identification and data input device are equally acceptable to the system and within the scope and spirit of the present invention. The information is received by the system and transmitted through a hardwired or wireless means to a central computer. The central computer also includes a user friendly monitor display to show the status in real time of play throughout the poker room.

If a player wants to take a break from play, such as for example to go to eat, then the dealer presses a button on the control panel to indicate that the player is still assigned to a particular seat, but that the player is temporarily away from the poker table thus pausing the count of player live time. This action is referred to herein as “lobbying”.

When the player returns, the dealer presses the player's button on the control panel again to indicate the player's return to the table thus restarting the count of player live time. All of the time that the player is recognized as logged into the system, a clock keeps track of the accumulated live play and lobbying time for that player. When the player is through playing, then the dealer simply presses another button to log the player out of the system. This immediately notifies the supervisors that a seat is now open. If there is a queue or waiting list for the current game at the table where the player leaves, the system notifies the supervisors and players of the next player up on the queue for that game and which table and seat is open. When a player has accumulated a predetermined amount of live playing time, then the casino owner will award the player with a comp.

As previously described, the system of the present invention automatically tracks a poker player's time at a poker table in a casino or other gaming establishment. It also tracks the number of hands played, indicates the need for a supervisor decision, indicates when a player needs food or beverage service, and indicates when a chip fill or credit is needed at a table. To accomplish the goal of developing a commercial application, the system provides electronic computer hardware and software that registers a client player and designates that player's seat position at the table. This is accomplished with a commercial magnetic card swipe reader along with a series of LED buttons or other means of display.

The system also sends data from the magnetic card reader and keypad into the main pit (i.e. central) computer. To accomplish this, a computer board accepts data from the magnetic card reader and LED buttons. These boards have hardwired or wireless transmission capabilities from any table in the poker room to one central computer for identification and processing.

Finally, the system stores data into a player tracking database program for viewing analysis, and maintenance. The program may be written in Visual Studio using a SQL Server database for storage, or other medium. These and other features of the present invention will be apparent to those skilled in the art.

### BRIEF DESCRIPTION OF THE DRAWINGS

So that the manner in which the above recited features, advantages, and objects of the present invention are attained and can be understood in detail, more particular description of the invention, briefly summarized above, may be had by reference to embodiments thereof which are illustrated in the appended drawings.

FIG. 1 is a plan view of one poker table incorporating certain aspects of the system of the present invention.

FIG. 2 is a detail view of the data input aspects available to the dealer at each table in accordance with this invention.

FIG. 3 is a schematic of the system architecture of the present invention showing one of a plurality of tables connected to a central computer in a hardwired configuration.

FIG. 4 is a schematic of the system architecture of the present invention showing one of a plurality of tables connected to a central computer in a wireless configuration.

FIG. 5 is a screen display of an aspect of the system at the central computer.

FIG. 6 is a top view of a presently preferred embodiment of a control panel at the disposal of the dealer.

### DETAILED DESCRIPTION OF PREFERRED EMBODIMENTS

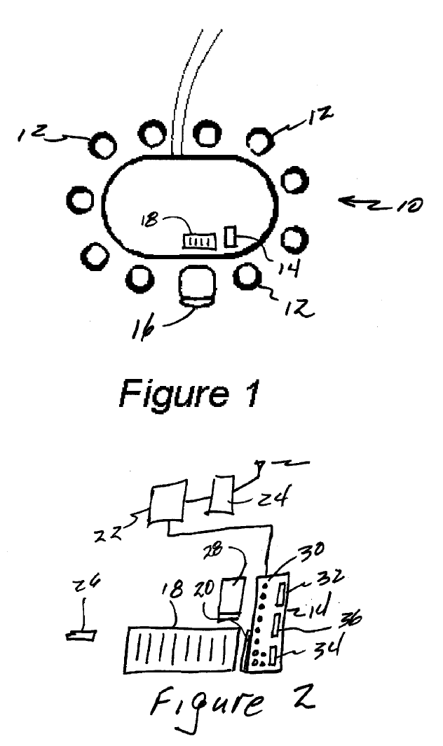

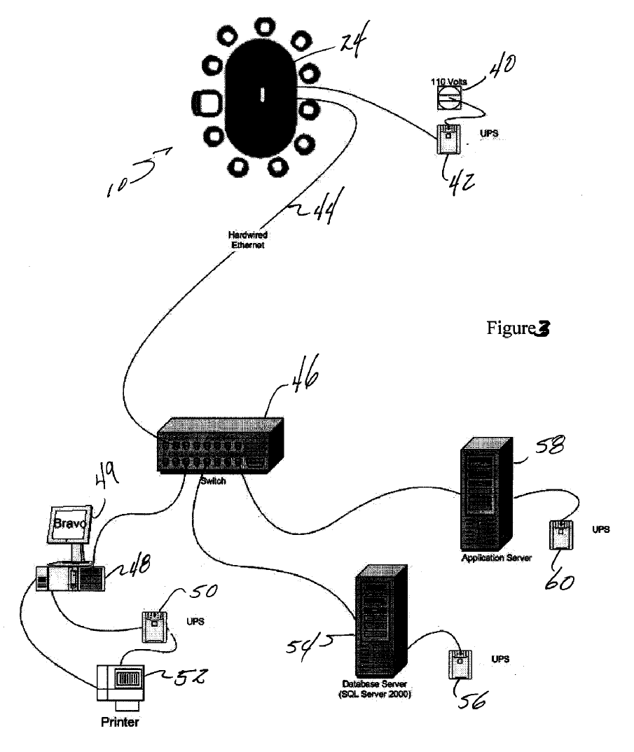

FIGS. 1 and 2 together illustrate a gaming table 10 and controls associated therewith installed as a portion of a system of the present invention. The system of this invention is specifically designed to permit quick and inexpensive retrofit of existing gaming tables or as an original manufacture option for a gaming table installed in a casino to incorporate this invention. Another advantage of the present invention resides in the fact that some of the gaming tables 10 may be fitted with the controls of this invention independent of other tables in the same poker room which are not fitted with the controls.

Referring now to FIGS. 1 and 2, the table 10 is shown with a plurality of player areas (seats) 12, of which ten such areas are illustrated, although more or preferably fewer may be so designated. A control panel 14 is installed on the table at a location easily accessible to the dealer, such as adjacent a dealer location 16. A chip rack 18 is also typically present directly in front of the dealer's station. Further details of the control panel and its associated components are provided in FIG. 2 and the presently preferred embodiment of the control panel 14 itself is shown and described below in respect of FIG. 6.

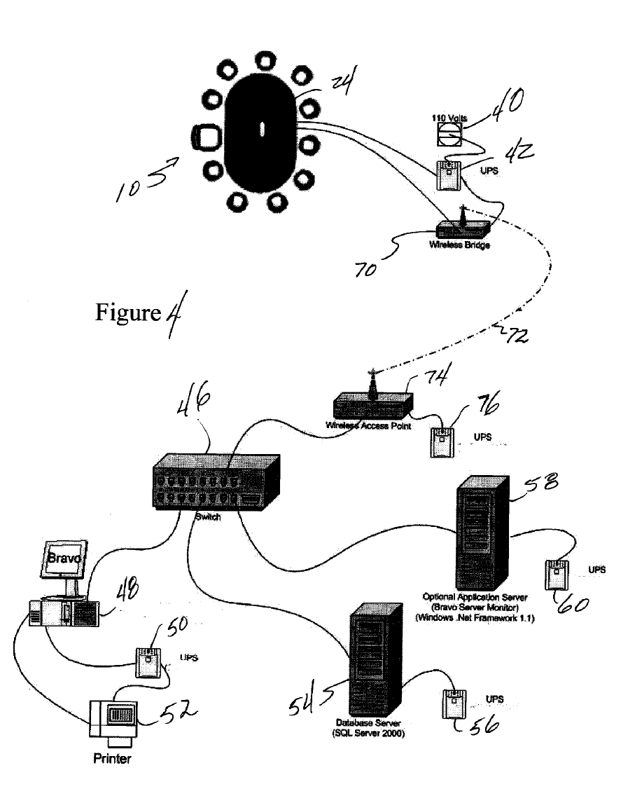

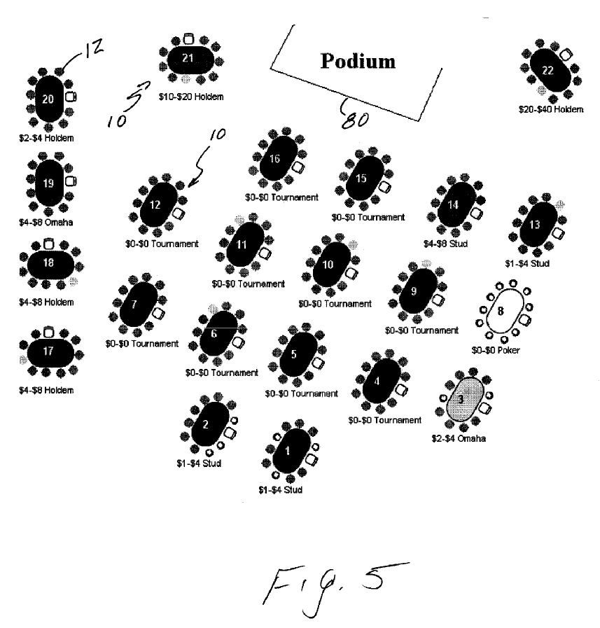

In operation, when a player approaches the table and wants to sit down to play, if a player area 12 is both unoccupied and unreserved, as described below, the dealer takes the player's magnetic identification card and swipes the players identifying data at a card reader 20 on the control panel 14. Data from the card, for tracking and other purposes, is gathered at a terminal device 22, preferably located below table level. Data is packetized and transmitted in bursts from a transmitter 24 to a central computer for the casino, shown and described below in respect of FIGS. 3 and 4.

In addition, a player may be added from the central computer via a magnetic card swipe or “player lookup” function. When a player is added from the central computer, data is sent to the panel at the table to activate the LED associated with the player's seat. A player may also be added as a “guest” from the table panel or from the central computer when he doesn't have a player's card or wishes not to use one. The player may later be associated with his player account from the central computer.

The system incorporates an existing casino drop 28 or jackpot drop 26 where chips are placed. For each hand, the dealer inserts one or more chips into the casino or jackpot drop. The jackpot drop or casino drop may be used to track the number of hands being played at that particular table.

The control panel 14 includes a plurality of buttons 30, one button designating each of the player areas 12. An unlit button indicates that no one is sitting at that designated player area, and thus anyone can sit there and begin to play. A lighted button indicates that a player has logged in and is currently playing at that designated area. If a player gets up to take a break, then the dealer logs that player as temporarily away (i.e. “lobbying”), and the button begins to glow at a lower intensity and/or with a low level pulse, for example. This indicates that no one is currently sitting at that area, but it is reserved for when the player returns. Once the player returns and is logged back into play at that table, the button is pressed and it reverts to glowing with a steady glow.

The control panel 14 includes the controls for illumination of the buttons 30 as just described. The control panel also includes a button 32 to call for services, as described below, and a button 34 for summoning a supervisor or moving a player from one seat to another, also as described below. Finally, an “In/Out” button is provided for the dealer to log a player out of the system when he is through playing. The “In/Out” button may also be used for dealer login at the table and for a call for chip service.

FIGS. 3 and 4 illustrate an overall system diagram of the system of the present invention. FIG. 3 shows a hardwired configuration of the system, while FIG. 4 illustrates a wireless configuration.

Referring first to FIG. 3, each table which is incorporated into an overall system of this invention includes a transmitter 24, as previously described, to send data from the table, including log-in and log-out data regarding the players at that table. The electronics at the table, including the control panel and the transmitter, are powered from a power source 40 and preferably an uninterruptible power supply (UPS) 42. A UPS is a power supply that includes a battery to maintain power in the event of a power outage. Typically, a UPS keeps a computer running for several minutes after a power outage, enabling the operator to save data that is in RAM and shut down the computer gracefully. Many UPSs now offer a software component that enables one to automate backup and shut down procedures in case there is a power failure while the computer is unattended, for some reason. For the present application, maintenance of the continuity of power is important to the good will of the casino, particularly in compensating the good clients of that casino.

In the embodiment of FIG. 3, data from the transmitter 24 is transmitted over a communications cable 44, such as a hardwired Ethernet cable as shown, to a switch 46. The switch 46 acts as a multiplexer, receiving data packets from the plurality of tables distributed around the poker room, and sending the data to a number of stations for manipulation, analysis, and storage. The station which receives data from and transmits data to the switch 46 is the application server 58 with its own UPS 60, which acts as a gateway between the transmitter and the database server and the central computer.

The station which receives data from the application server 58 is a database server 54 powered by its own UPS 56. The server 54, preferably a structured query language (SQL) type server, maintains the customer records, accounting data, historical data, records of play at the casino, player queue data, and the like. The station which retrieves data from the database server 54 and transmits data to the application server 58 and database server 54 is a central computer 48, also referred to herein as the main “pit” computer. The central computer is responsible for displaying the activity throughout the poker room to a supervisor, for which the central computer 48 is provided with a monitor or graphical user interface 49. The central computer is also provided with a printer for printing hard copy reports, as required, and the central computer and peripheral equipment may be powered from a UPS 50.

The embodiment illustrated in FIG. 4 includes the same basic elemental building blocks as the embodiment of FIG. 3, except that the various tables communicate with the application server wirelessly. Each table includes a wireless bridge 70 which is powered by the UPS 42 which powers the electronics of the table 10. The wireless bridge transmits to a wireless access point 74 which is powered by a dedicated UPS 76. The wireless bridge communicates wirelessly, as indicated by a dotted line 72 in the drawing figure. The great advantage in this, the presently preferred embodiment of the invention, is that cables 44 need not be strung throughout the casino floor in order for the tables to communicate with the application server 48.

Now that the basic structure of the system has been described, those of skill in the art will understand the following description of the operation of this invention.

Operating Procedure

To begin play, a player sits at a poker table (table 1, seat 1 at a seat 12) and hands the dealer his player's card. The player's card includes a magnetic stripe in the conventional fashion to carry the player's identifying data. The dealer swipes data from the card into the magnetic card reader on the control panel 14 and the dealer pushes the LED button #1 of the buttons 30. This sends a data signal (name and any other information on the card) from the transmitter 24 to the application server 58 and logs the player into the system at table 1, seat 1. Button #1 is illuminated with a steady glow indicating the player's time starts. If the player does not have a player's card, the dealer registers the player as a guest by pressing the In/Out button 86, for example, and the above procedure is repeated. The guest may also be logged into the system as described below in respect of the preferred embodiment of the control panel 14.

Any time a player leaves the game temporarily, the dealer presses the associated seat number button 30 and the player's time stops. The indicator light associated with the seat to which the player was assigned begins to blink. When the player returns, the button is pressed and his time is started again, at which time the light glows steadily again. When a player leaves the game, an In/Out Button 86 is pressed then the player's seat number button is pressed and the player is checked out. Other visual indicators of “logged in”, “lobbying”, and “logged out” may of course be used.

If at any time during play, a problem with the game arises, (player betting out of turn, dealer misinterpreting a player, etc.) the pit supervisor must come to the table to correct the problem. The pit supervisor may be summoned or signaled with the appropriate supervisor decision button 89 on the control panel 14 by holding down the button for 2.5 seconds. Notification can be accomplished by visual display, emailing, paging, internet or automated public announcement. After the problem has been resolved, the supervisor or dealer presses the decision button for 2.5 seconds to turn the signal off. The decision is later noted and categorized at the central computer. The number of times a decision has to be made as well as the particular decision made is tracked.

If a player needs beverage or food service, the dealer presses the service button 88 and the data is sent to the service department that service is need at the table. Notification can be accomplished by visual display, emailing, paging, Internet or automated public announcement.

If chip fill or credit is needed at the table, the dealer presses and holds the In/Out button 86 for 2.5 seconds. Notification can be accomplished by visual display, emailing, paging, internet or automated public announcement.

The system tracks the number of hands played by a light or mechanical sensor placed in the casino drop slot 28 or jackpot drop 26 indicating a played hand when chips are dropped. This can also be accomplished with the pressing of a button, switch, voice recognition, etc.

Thus, the system as just described tracks the total accumulated time for each player. Once a player accumulates a total predetermined time of playing at poker tables, for example fifty hours, the casino typically will want to reward the player with a comp.

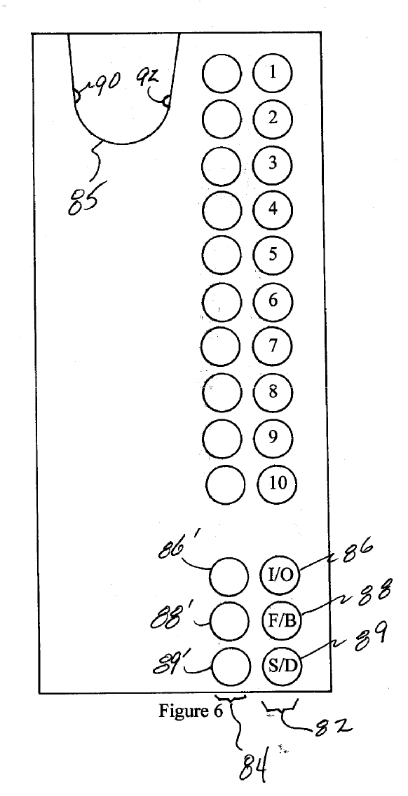

As previously described, the present invention also provides a means for a supervisor to track the progress of play, and during certain circumstances, such as during a tournament, to direct certain aspects of poker play throughout the poker room. The present invention also facilitates the management of a queue of players waiting for a seat vacancy in a desired game. FIG. 5 depicts a screen display 100 of one aspect of this monitoring function provided on the monitor 49 as the central computer 49. The screen display is a scale model of the layout of the poker room, and includes a depiction of a podium 80, for example, where the pit supervisor will typically be posted. The display includes the plurality of tables 10, each includes a number of player seats 12. For the ease of the supervisor, the tables are displayed in a variety of colors, such as for example:

| | |
|---|---|
| White | Table Closed |
| Yellow | 1 or 2 Seats Open |
| Red | 3 or more Seats Open |
| Green | Table Full |
| Blue | Tournament Table |

The players seats 12 shown on the screen may also be color coded according to the following scheme:

| | |
|---|---|
| White | Seat Open |
| Yellow | Lobby less than 15 minutes |
| Red | Lobby 15 minutes or more |
| Green | Seat Occupied |

Each table may also include a legend 102 showing the game and stakes at each table. For example, the table that is numbered “20 ” in FIG. 5 includes the legend that this table is a $2-$4 Hold'em table, etc. Note also that a tournament may be carried out alongside other non-tournament tables within the scope and spirit of the invention.

FIG. 6 depicts a presently preferred embodiment of a control panel 14 of the invention. The control panel includes a row of buttons 82 and a corresponding row of indicator lights 84. The control panel displayed is presently preferred because it combines the best features of low cost and durability in the environment in which the invention finds application. The buttons 82 are numbered 1-10, corresponding to the seats 12 at the table. Fewer seats may be used, if desired. Each control button 82 includes an indicator light 84 associated with it.

The panel 14 also includes an input/output (I/O) button 86 with an associated indicator light 86′; a food/beverage (F/B) button 88 with an associated indicator light 88′; and a supervisor/decision button 89 with an associated indicator light 89′. The functions of these buttons and indicator lights will be described below.

The panel 14 also includes a hand counter 85. For each hand that is dealt, the dealer inserts a chip from the ante pile into the counter 85. The counter includes a lamp 90 and a photodiode 92. So long as the photodiode detects a light from the lamp 90, the system is in steady state. When a chip passes between the lamp and the diode, the hand counter associated with that table is incremented, thus keeping an accurate track of the number of hands dealt at that table and by the dealer that is logged into that table. Hand counts can also be monitored with a light sensor placed in the casino drop 28. When the dealer pulls back the drop a photo sensor detects ambient light and the hand counter associated with that table is incremented, thus keeping an accurate track of the number of hands dealt at that table and by the dealer that is logged into that table.

The control panel provides a means for the system to keep track of the accumulated time played by each player at the table. To check a player into a seat, the dealer swipes the player's card (the I/O light 86′ goes on). The dealer then presses a seat number button 82 (the seat light 84 goes on and I/O light 86′ goes off). If the player does not present the dealer with an identification card, the dealer may press the I/O button 86 (the I/O 86′ light goes on) and then presses seat number button 82 (the seat light 84 goes on and I/O light 86′ goes off). If desired, the player may be logged into the system by a pit supervisor or other casino personnel at the central computer 48.

To check a player out of a seat, the dealer presses the I/O button 86 and then presses the seat number 82 to which the player was assigned (the seat light 84 goes off). Alternatively, the player may be checked out the system by a pit supervisor at the central computer.

To place a player in “lobby” (i.e. to temporarily turn off the tracking clock, but keep the seat reserved for the player), the dealer presses the seat number of guest in lobby (the player's seat light 84 flashes). This action turns the seat indicator on the display 100 to a yellow color. To take a player out of “lobby”, the dealer presses the seat number 82 of the player in lobby and the seat light 84 goes on steady.

To check a dealer into a table, the dealer swipes his employee identification card with the card reader 20 (the I/O light 86′ goes on) and the he presses the I/O button 86 (the I/O light 86′ goes off). Alternatively, a pit supervisor may log the dealer into the system at the central computer.

To mark a supervisor decision at table, the dealer holds down the S/D button 89 for 2.5 seconds (the S/D light will blink to signal acceptance) and then the supervisor clicks on a decision icon and classifies the decision at the central computer, or a similar action.

To move a player from one seat to another seat, the dealer presses the S/D button 89 and then presses the control button 82 for the seat from which the player is moving and then the control button 82 for the seat to which the player is moving. If the player wishes to move from one table to another, he is logged out of the system at the table that he is moving from and logs back into the system at the new table. Alternatively, a pit supervisor may move the player from seat to seat or table to table at the central computer.

To request a chip fill or credit, the dealer presses the I/O button for 2.5 seconds (the I/O button will blink to signal acceptance).

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A system for monitoring play at a poker table, the poker table defining a plurality of player areas, the system comprising:
a. a control panel at the poker table to receive player identification information into the system;
b. means for indicating when a specific player area is unoccupied, occupied, or reserved;
c. a central computer; and
d. a terminal device at the poker table for receiving data from the control panel and transmitting that data to the central computer.

2. The system of claim 1, further comprising a transmitter to transmit data from the terminal device to the central computer.

3. The system of claim 2, further comprising a cable between the transmitter and the central computer.

4. The system of claim 2, further comprising a wireless bridge in communication with the transmitter and a wireless access point to receive data from the wireless bridge.

5. The system of claim 1, further comprising means for tracking accumulated playing time of the player.

6. The system of claim 1, wherein the control panel includes a plurality of control buttons, one button associated with each of the plurality of player areas at that table.

7. The system of claim 6, further comprising an indicator light associated with each control button.

8. The system of claim 1, further comprising a graphical user interface at the central computer.

9. The system of claim 1, further comprising means for tracking a plurality of poker players during tournament play at the poker table.

10. The system of claim 1, further comprising means for maintaining a waiting list of players awaiting play at the poker table.

11. The system of claim 1, further comprising means for summoning a supervisor to the poker table.

12. The system of claim 1, further comprising means for summoning food and beverage personnel to the poker table.

13. The system of claim 1, further comprising means for summoning personnel to the poker table for player chips, table chip “fills” and table chip “credits”.

14. The system of claim 1, further comprising means for counting the number of poker hands played at the poker table.

15. A system for monitoring play in a poker room having a plurality of poker tables, each of the plurality of poker tables defining a plurality of player areas, the system comprising:
a. a control panel at at least two of the poker tables to receive player identification information into the system;
b. means for indicating when a specific player area is unoccupied, occupied, or reserved;
c. a central computer; and
d. a terminal device at each of the at least two poker tables for receiving data from the control panel and transmitting that data to the central computer.

16. The system of claim 15, further comprising a transmitter at each of the at least two poker tables to transmit data from each terminal device to the central computer.

17. The system of claim 16, further comprising a cable between the transmitters and the central computer.

18. The system of claim 16, further comprising a wireless bridge in communication with the transmitters and a wireless access point to receive data from the wireless bridge.

19. The system of claim 15, further comprising means for tracking accumulated playing time of each player at the plurality of tables.

20. The system of claim 15, wherein each control panel includes a plurality of control buttons, one button associated with each of the plurality of player areas at a specific table.

21. The system of claim 20, further comprising an indicator light associated with each control button.

22. The system of claim 15, further comprising a graphical user interface at the central computer.

23. The system of claim 15, further comprising means for tracking a plurality of poker players during tournament play at the plurality of poker tables.

24. The system of claim 15, further comprising means for maintaining a waiting list of players awaiting play at the plurality of poker tables.

25. The system of claim 15, further comprising means for summoning a supervisor to the plurality of poker tables.

26. The system of claim 15, further comprising means for summoning food and beverage personnel to the plurality of poker tables.

27. The system of claim 15, further comprising means for summoning personnel to the plurality of poker tables for player chips, table chip “fills” and table chip “credits”.

28. The system of claim 15, further comprising means for counting the number of poker hands played at the plurality of poker tables.
